(19) United States
(12) Patent Application Publication
(10) Pub. No.: US 2019/0151973 A1
(43) Pub. Date: May 23, 2019

(54) ALUMINUM ALLOY BRAZING SHEET AND METHOD FOR MANUFACTURING HEAT EXCHANGER FORMED OF ALUMINUM ALLOY

(71) Applicants: UACJ Corporation, Tokyo (JP); DENSO CORPORATION, Kariya-shi, Aichi (JP)

(72) Inventors: Yasunaga Itoh, Tokyo (JP); Tomoki Yamayoshi, Tokyo (JP); Shingo Oono, Kariya-shi (JP); Tomohiro Shimazu, Kariya-shi (JP); Shin Takewaka, Kariya-shi (JP)

(73) Assignees: UACJ Corporation, Tokyo (JP); DENSO CORPORATION, Kariya-shi, Aichi (JP)

(21) Appl. No.: 16/066,483

(22) PCT Filed: Nov. 28, 2016
(86) PCT No.: PCT/JP2016/085226

§ 371 Date: Jun. 27, 2018

(30) Foreign Application Priority Data
Dec. 28, 2015 (JP) 2015-256944

(51) Int. Cl. B23K 1/00; B23K 1/20; B23K 35/02; B23K 35/28

(52) U.S. Cl. CPC B23K 1/0012; B23K 1/20; B23K 2101/14; B23K 35/288; B23K 35/0238

(57) ABSTRACT

An aluminum alloy brazing sheet used for brazing in an inert gas atmosphere without using flux is provided. In the aluminum alloy brazing sheet, a brazing material formed of aluminum alloy including Si of 6 mass % to 13 mass % with the balance being Al and inevitable impurities clads one side surface or both side surfaces of a core material formed of aluminum alloy including Mn of 0.8 mass % to 1.8 mass %, and Mg of 0.05 mass % to 0.20 mass % with the balance being Al and inevitable impurities, the brazing sheet has a thickness of 0.12 mm or smaller, and the brazing material has a thickness of 0.012 mm or smaller. This structure provides an aluminum alloy brazing sheet for fluxless brazing causing no defectiveness of buckling of distal end portions of fins or unsound formation of a fillet in brazing heating.

### TECHNICAL FIELD

The present invention relates to an aluminum alloy brazing sheet used for brazing of aluminum or aluminum alloy in an inert gas atmosphere without using flux, and a method for manufacturing a heat exchanger formed of aluminum alloy and using the same.

### BACKGROUND ART

Braze joining is widely used as a joining method, in heat exchangers (mainly heat exchangers for automobiles) formed of aluminum and including a number of fine joined parts. Braze joining aluminum requires breaking an oxide film covering a surface of a brazing material, and bringing the molten brazing material into contact with a base material or another molten brazing material.

Flux is generally used for breaking an oxide film. A method of applying fluoride-based flux to perform brazing in an inert gas atmosphere, such as nitrogen gas, is widely used for joining aluminum brazed products represented by heat exchangers for automobiles. However, in recent years, computerization of automobiles have made rapid progress, and residue of flux has been regarded as a problem in heat exchangers contacting electronic components. In addition, because residue of flux damages surface treatability, residue of flux is washed off after brazing in some heat exchangers. Load of cost for the washing process has also been regarded as a problem.

For this reason, putting a fluxless brazing method into practical use is expected. The fluxless brazing method is a method of performing joining in an inert gas atmosphere without application of flux. To break an oxide film (mainly Al₂O₃) without using flux requires a material including an element with low oxide generation free energy, that is, an element easy to oxidize. Mg is used as the most representative example of the element.

In brazing of aluminum products, a brazing sheet in which a brazing material clads a surface of a core material is frequently used. Regions to which Mg is added are roughly classified into two types, that is, the core material, and the brazing material. Adding Mg to the core material is more advantageous to avoid adverse influence of oxidation due to oxygen and/or water vapor existing with a very small quantity in the brazing atmosphere (see Japanese Patent Application Publication Nos. 2004-358519-A, 2006-043735-A, 2011-025276-A, 2011-230128-A, 2013-123749-A, 2013-233552-A, 2015-30861-A, and 2015-58466-A). Mg added to the core material is diffused into the brazing material layer during brazing heating, and reduces the oxide film, at the stage of reaching the surface of the brazing material, to form a spinel-type oxide (Al₂MgO₄) and embrittle the oxide film. However, when the timing at which Mg reaches the surface of the brazing material is delayed, or when the quantity of Mg reaching the surface is small, embrittlement of the oxide film does not sufficiently make progress, and sound brazability is not obtained. For this reason, as disclosed in the patent publications mentioned above, addition of Mg of 0.2 mass % or larger to the core material is required to secure joining property.

### PRIOR ART LITERATURES

### Patent Literatures

Patent Literature 1: Japanese Patent Application Publication No. 2004-358519-A
Patent Literature 2: Japanese Patent Application Publication No. 2006-043735-A
Patent Literature 3: Japanese Patent Application Publication No. 2011-025276-A
Patent Literature 4: Japanese Patent Application Publication No. 2011-230128-A
Patent Literature 5: Japanese Patent Application Publication No. 2013-123749-A
Patent Literature 6: Japanese Patent Application Publication No. 2013-233552-A
Patent Literature 7: Japanese Patent Application Publication No. 2015-30861-A
Patent Literature 8: Japanese Patent Application Publication No. 2015-58466-A

### SUMMARY OF INVENTION

### Problem to be Solved by Invention

At present, most of heat exchangers serving as targets for development of fluxless brazing have a hollow structure. The thickness of members forming a hollow structure is 0.6 mm or larger in the tank and the header portion of a parallel-flow-type heat exchanger, larger than 0.2 mm in the tube portion thereof and 0.4 mm or larger in main member tube portion of a stacked type heat exchanger. To enable fluxless brazing in a brazing sheet used for these members having a thickness exceeding 0.2 mm, the core material is required to include Mg of 0.2 mass % or larger.

By contrast, in parallel-flow-type heat exchangers and/or stacked type heat exchangers, brazing fins (commonly called “outer fins”) set between tubes, and/or brazing fins (commonly called “inner fins”) set inside the tube have a small thickness of 0.1 mm or smaller.

In brazing fin materials having a small thickness of 0.1 mm, failures frequently occur, such as buckling of distal end portions of the fins, and unsound formation of a fillet. Such failures are not prevented, by simply reducing the thickness of the brazing sheet having a thickness of 0.6 mm or larger in the tank and the header portion of a parallel-flow-type heat exchanger, the brazing sheet having a thickness larger than 0.2 mm in the tube portion thereof, or the brazing sheet having a thickness of 0.4 mm or larger in the main member tube portion of a stacked type heat exchanger.

Accordingly, an object of the present invention is to provide an aluminum alloy brazing sheet brazed without using flux, and preventing failure, such as buckling of a distal end portion of the fin and unsound formation of a fillet, in brazing heating, even with a small thickness of 0.12 mm or smaller.

### Means for Solving the Problem

In such circumstances, as a result of repeated diligent researches, the inventors of the present invention have found that setting the thickness of the brazing material to 0.012 mm or smaller secures sufficient diffusion of Mg into a surface of the brazing material, even when the Mg content in the core material is set to 0.2 mass % or smaller, although prior art requires the Mg content in the core material of 0.2 mass % or larger in fluxless brazing. In addition, with respect to defective brazing caused by reduction in the absolute quantity of molten brazing material due to setting of the thickness of the brazing material to 0.012 mm or smaller, the inventors of the present invention have found that setting the Mg content in the core material to 0.2 mass % or smaller suppresses miniaturization of recrystallized grains in the core material in brazing heating, reduces grain boundary penetration of the molten brazing material into the core material, and consequently secures the absolute quantity of molten brazing material contributing to formation of a fillet necessary for sound brazing. This structure enables formation of a sound fillet, and reduces grain boundary penetration of the brazing material into the core material in brazing heating, to prevent buckling of distal end portions of fins. Based on the finding described above, the inventors have made the present invention.

Specifically, the present invention (1) provides an aluminum alloy brazing sheet used for brazing in an inert gas atmosphere without using flux, wherein

a brazing material formed of aluminum alloy including Si of 6 mass % to 13 mass % with the balance being Al and inevitable impurities clads one side surface or both side surfaces of a core material formed of aluminum alloy including Mn of 0.8 mass % to 1.8 mass %, and Mg of 0.05 mass % to 0.20 mass % with the balance being Al and inevitable impurities,

the brazing sheet has a thickness of 0.12 mm or smaller, and

the brazing material has a thickness of 0.012 mm or smaller.

The present invention (2) provides a method for manufacturing a heat exchanger formed of aluminum alloy, comprising:

forming the aluminum alloy brazing sheet of (1) into a fin shape to prepare fins;

setting the fins between tubes formed of aluminum alloy; and

performing brazing, without applying flux, in an inert gas atmosphere with an oxygen concentration limited to 20 ppm or lower.

The present invention (3) provides a method for manufacturing a heat exchanger formed of aluminum alloy, comprising:

forming the aluminum alloy brazing sheet of (1) into a fin shape to prepare fins;

setting the fins inside a tube formed of aluminum alloy, and

performing brazing, without applying flux, in an inert gas atmosphere with an oxygen concentration limited to 50 ppm or lower.

### Effects of Invention

The present invention provides an aluminum alloy brazing sheet brazed without application of flux, and enabling prevention of buckling of distal end portions of fins and sound formation of a fillet, in brazing heating, even with a small thickness of 0.12 mm or smaller.

### BRIEF EXPLANATION OF DRAWINGS

FIG. 1 is a test piece for outer fins; and

FIG. 2 is a sectional view of a test piece for inner fins.

### EMBODIMENTS OF THE INVENTION

The present invention is an aluminum alloy brazing sheet used for brazing in an inert gas atmosphere without using flux, wherein a brazing material formed of aluminum alloy including Si of 6 mass % to 13 mass % with the balance being Al and inevitable impurities clads one side surface or both side surfaces of a core material formed of aluminum alloy including Mn of 0.8 mass % to 1.8 mass %, and Mg of 0.05 mass % to 0.20 mass % with the balance being Al and inevitable impurities, the brazing sheet has a thickness of 0.12 mm or smaller, and the brazing material has a thickness of 0.012 mm or smaller.

The aluminum alloy brazing sheet according to the present invention is an aluminum alloy brazing sheet used for fluxless brazing, in which brazing is performed in an inert gas atmosphere without using flux.

The aluminum alloy brazing sheet according to the present invention includes a core material and a brazing material cladding one side surface or both side surfaces of the core material. Specifically, in the aluminum alloy brazing sheet according to the present invention, the brazing material clads one side surface or both side surfaces of the core material.

The core material is a core material of aluminum alloy including Mn of 0.8 mass % to 1.8 mass %, and Mg of 0.05 mass % to 0.20 mass % with the balance being Al and inevitable impurities. The core material includes Mn and Mg as indispensable elements.

The Mn content in the core material is 0.8 mass % to 1.8 mass %, and preferably 1.0 mass % to 1.4 mass %. The Mn content in the core material falling within the range described above secures strength necessary for fins, and increases the potential of the fins, to decrease the corrosion rate of the fins. In addition, Mn suppresses generation of cores, and suppresses miniaturization of grains of the core material. By contrast, when the Mn content in the core material is smaller than the range described above, the Mn content excessively lowers the strength of the fins, and causes easy miniaturization of grains. In addition, the Mn content exceeding the range described above causes easy occurrence of cracks in rolling in manufacturing of the material.

The Mg content in the core material is 0.05 mass % to 0.2 mass %, and preferably 0.1 mass % to 0.16 mass %. The Mg content in the core material falling within the range described above enables diffusion of Mg of a quantity necessary for embritlling the oxide film into the surface of the brazing material in brazing heating, and improves the brazability. The Mg content falling within the range also prevents miniaturization of grains in the core material in brazing heating, and reduces grain boundary penetration of the brazing material into the core material. As a result, this structure secures sound brazability, and prevents buckling of distal end portions of fins. By contrast, when the Mg content in the core material is smaller than the range described above, the Mg content causes defective brazability, and fails to secure sound brazability. In addition, the Mg content exceeding the range described above causes miniaturization of grains of the core material in brazing heating, and increases grain boundary penetration of the brazing material into the core material. As a result, the Mg content exceeding the range causes defective brazability, and easily causes buckling of distal end portions of fins.

The ratio (Mg/Mn) of the Mg content to the Mn content in the core material is preferably 0.04 to 0.18, and more preferably 0.08 to 0.16. The ratio of the Mg content to the Mn content in the core material falling within the range described above enhances the effect of securing sound brazability and preventing buckling of distal end portions of fins.

The core material is a core material of aluminum alloy including Mn of 0.8 mass % to 1.8 mass %, and preferably 1.0 mass % to 1.4 mass %, Mg of 0.05 mass % to 0.20 mass %, and preferably 0.1 mass % to 0.16 mass %, and, one or two or more of Si of 1.0 mass % or smaller, and preferably 0.05 mass % to 0.6 mass %, Fe of 1.0 mass % or smaller, and preferably 0.05 mass % to 0.5 mass %, Cu of 0.5 mass % or smaller, and preferably 0.05 mass % to 0.2 mass % S, Zn of 3.0 mass % or smaller, and preferably 0.05 mass % to 2.5 mass % S, Ti of 0.2 mass % or smaller, and preferably 0.05 mass % to 0.08 mass %, and Zr of 0.5 mass % or smaller, and preferably 0.05 mass % to 0.08 mass %, with the balance being Al and inevitable impurities. The core material includes Mn and Mg as indispensable elements, and may include one or two or more of Si, Fe, Cu, Zn, Ti, and Zr as desired elements, if necessary.

The core material may include Si, or may include no Si. When the core material includes Si, the Si content in the core material is 1.0 mass % or smaller, and preferably 0.05 mass % to 0.6 mass %. The core material including Si of the range described above increases the strength of fins, reduces diffusion quantity of Si in the brazing material into the core material in brazing, and suppresses reduction in flow quantity of the brazing material. By contrast, the Si content in the core material exceeding the range described above increases the dissolution quantity of the core material caused by the molten brazing material, and reduces the melting point of the core material. The Si content exceeding the range easily causes deformation of fins, in particular, when the brazing temperature is high.

The core material may include Fe, or may include no Fe. When the core material includes Fe, the Fe content in the core material is 1.0 mass % or smaller, and preferably 0.05 mass % to 0.5 mass %. The core material including Fe of the range described above enhances the strength of fins. By contrast, when the Fe content in the core material exceeds the range described above, the corrosion rate may be increased, and early corrosion of fins may occur.

The core material may include Cu, or may include no Cu. When the core material includes Cu, the Cu content in the core material is 0.5 mass % or smaller, and preferably 0.05 mass % to 0.2 mass %. The core material including Cu of the range described above enhances the strength of fins. By contrast, the Cu content in the core material exceeding the range described above lowers the melting point of the fins, to easily cause deformation of the fins in brazing heating. In addition, the Cu content exceeding the range may increase the potential of the fins, and increase the corrosion rate of the tube.

The core material may include Zn, or may include no Zn. When the core material includes Zn, the Zn content in the core material is 3.0 mass % or smaller, and preferably 0.05 mass % to 2.5 mass %. The core material including Zn of the range described above decreases the potential of the fins, to exhibit a sacrificial anode effect. By contrast, the Zn content in the core material exceeding the range described above excessively lowers the potential of the fins, and easily causes early corrosion of the fins and early separation of the fins.

The core material may include Ti, or may include no Ti. When the core material includes Ti, the Ti content in the core material is 0.2 mass % or smaller, and preferably 0.05 mass % to 0.08 mass %. The core material including Ti of the range described above causes corrosion to proceed in a layer manner, and prolongs the corrosion life. By contrast, the Ti content in the core material exceeding the range described above causes easy generation of coarse grains in casting, and deteriorates corrosion resistance and/or moldability.

The core material may include Zr, or may include no Zr. When the core material includes Zr, the Zr content in the core material is 0.5 mass % or smaller, and preferably 0.05 mass % to 0.08 mass %. The core material including Zr of the range described above delays recrystallization, and increases the grain size. By contrast, the Zr content in the core material exceeding the range described above easily causes cracks in manufacturing of the material.

The brazing material is an aluminum alloy brazing material formed of aluminum alloy including Si of 6 mass % to 13 mass % with the balance being Al and inevitable impurities.

The brazing material includes Si as an indispensable element. The Si content in the brazing material is 6 mass % to 13 mass %, and preferably 7.5 mass % to 12 mass %. The Si content in the brazing material falling within the range described above improves the flowability of the molten brazing material, and secures sound joining property. By contrast, the Si content in the brazing material smaller than the range described above causes scarce flowability of the molten brazing material, and causes unsound joining. In addition, the Si content in the brazing material exceeding the range described above increases the dissolution quantity of the core material caused by the molten brazing material, causes easy collapse of the top of the fin, and increases the risk that the brazing material layer cracks in rolling in manufacturing the material.

The brazing material also includes one or two or more of Li, Bi, and Mg, as desired elements, if necessary.

The brazing material may include Li. or may include no Li. When the brazing material includes Li, the Li content in the brazing material is 0.05 mass % or smaller, and preferably 0.004 mass % to 0.04 mass %. Li is an element with low oxide generation free energy, like Mg, and exhibits an effect of embrittling an oxide film with a quantity smaller than that of Mg. For this reason, the brazing material including Li of the range described above enhances the joining property. By contrast, the Li content in the brazing material exceeding the range described above causes easy oxidation during heating, and decreases the brazability.

The brazing material may include Bi, or may include no Bi. When the brazing material includes Bi, the Bi content in the brazing material is 0.1 mass % or smaller, and preferably 0.004 mass % to 0.05 mass %. The brazing material including Bi of the range described above lowers the surface tension of the molten brazing material, improves the flowability of the brazing material, and enhances the clearance filling property. By contrast, the Bi content in the brazing material exceeding the range described above causes easy oxidation of the surface of the brazing material during heating, and deteriorates the joining property.

The brazing material may include Mg, or may include no Mg. When the brazing material includes Mg, the Mg content in the brazing material is 0.1 mass % or smaller, and preferably 0.02 mass % to 0.1 mass %. The brazing material including Mg of the range described above lowers the surface tension of the molten brazing material, improves the flowability of the brazing material, and enhances the clearance filling property. By contrast, the Mg content in the brazing material exceeding the range described above decreases the joining property, under the condition that the oxygen concentration in the heating atmosphere is high.

The aluminum alloy brazing sheet according to the present invention has a thickness of 0.12 mm or smaller, and preferably 0.05 mm to 0.12 mm. The aluminum alloy brazing sheet according to the present invention has a small thickness of 0.12 mm or smaller, and is suitably used for brazing fins (outer fins) set between tubes of a parallel-flow-type heat exchanger or a stacked type heat exchanger, and/or brazing fins (inner fins) set inside a tube thereof.

The brazing material has a thickness of 0.012 mm or smaller, and preferably 0.005 mm to 0.010 mm. The brazing material having a thickness falling within the range described above improves brazability, and enables formation of a sound fillet. By contrast, the brazing material having a thickness exceeding the range described above causes insufficient diffusion of Mg into the surface of the brazing material, causes insufficient embrittlement of the oxide film, and fails to enable sound brazability.

The core material has a thickness of 0.11 mm or smaller, and preferably 0.04 mm to 0.1 mm. The aluminum alloy brazing sheet according to the present invention has a structure in which the brazing material has a thickness of 0.012 mm or smaller, and preferably 0.005 mm to 0.010 mm, although the core material has a small thickness of 0.11 mm or smaller, and preferably 0.04 mm to 0.1 mm. This structure enables sound brazability, even when the Mg content in the core material is small, that is, 0.05 mass % to 2.0 mass %, and preferably 0.1 mass % to 0.16 mass %.

The brazing material of the aluminum alloy brazing sheet according to the present invention has a clad ratio of 5% to 15%, and preferably 7% to 12%.

In the aluminum alloy brazing sheet according to the present invention, the core material is preferably formed of aluminum alloy having an average grain size of 50 μm or larger after heating test at 595° C. The aluminum alloy brazing sheet according to the present invention has a structure in which the core material is formed of aluminum alloy having an average grain size of 50 μm or larger after heating test at 595° C. This structure prevents the grains from becoming too small, even when the aluminum alloy brazing sheet is heated at a brazing heating temperature of 577° C. to 610° C. in brazing heating. This structure reduces grain boundary penetration of the molten brazing material. Consequently, this structure enables sound brazability, and prevents buckling of distal end portions of the fins. In addition, the Mn content in the core material is set to 0.8 mass % to 1.8 mass %, and preferably 1.0 mass % to 1.4 mass %, and the Mg content is set to 0.05 mass % to 0.2 mass %, and preferably 0.1 mass % to 0.16 mass %. This structure secures the core material formed of aluminum alloy having the average grain size of 50 μm or larger after heating test at 595° C.

In the aluminum alloy brazing sheet according to the present invention, the core material is preferably formed of aluminum alloy having an average grain size of 50 μm or larger after brazing heating at 577° C. to 610° C. The aluminum alloy brazing sheet according to the present invention has a structure in which the core material is formed of aluminum alloy having an average grain size of 50 μm or larger after brazing heating at 577° C. to 610° C. This structure prevents the grains from becoming too small in brazing heating, and reduces grain boundary penetration of the molten brazing material. Consequently, this structure enables sound brazability, and prevents buckling of distal end portions of the fins. In addition, the Mn content in the core material is set to 0.8 mass % to 1.8 mass %, and preferably 1.0 mass % to 1.4 mass %, and the Mg content is set to 0.05 mass % to 0.2 mass %, and preferably 0.1 mass % to 0.16 mass %. This structure secures the core material formed of aluminum alloy having the average grain size of 50 μm or larger after brazing heating at 577° C. to 610° C.

The aluminum alloy brazing sheet according to the present invention may have a structure in which a surface oxide film, or the surface oxide film and the brazing material, may be etched by acid treatment to a thickness of 5 nm or larger. Because the structure in which the surface of the brazing material is etched is a structure in which an oxide film on the surface of the brazing material has been embrittled, the brazability is improved. Performing etching at the stage at or after hot rolling in manufacturing of the material removes the necessity for performing etching in a brazed product production plant. As another example, etching may be performed at a step before brazing heating is performed after the material is finished. Etching with an alkaline solution is not preferable, because aluminum hydroxide or the like generated in etching is decomposed in brazing heating to emit moisture. Applying oil after etching is effective, to retain the etching effect for a long period of time. To prevent the oil to be applied from damaging the brazability, it is necessary that the decomposition temperature in the inert gas atmosphere is 380° C. or lower. In the case of applying oil having a decomposition temperature exceeding 380° C., degreasing is required before brazing. Although etching a hot-rolled coil requires no special treatment because rolling oil is applied in cold rolling, etching and oil application may be performed at the final stage of manufacturing of the material. An etching depth of 5 nm or larger is required, including the surface oxide film, to secure brazability. The etching depth smaller than 5 nm causes a scarce etching effect, and causes difficulty in securing brazability.

A method for manufacturing a heat exchanger formed of aluminum alloy according to the present invention is a method including: forming the aluminum alloy brazing sheet according to the present invention into a fin shape to prepare fins, setting the fins between tubes formed of aluminum alloy, and performing brazing, without applying flux, in an inert gas atmosphere with an oxygen concentration limited to 20 ppm or lower. The fins set between the tubes of the heat exchanger directly contacts the brazing atmosphere, and is oxidized with oxygen included in the brazing atmosphere during heating. For this reason, the oxygen concentration in the brazing atmosphere requires setting to 20 ppm or lower. The oxygen concentration in the brazing atmosphere exceeding 20 ppm causes difficulty in securing of sound brazability.

A method for manufacturing a heat exchanger formed of aluminum alloy according to the present invention is a method for manufacturing a heat exchanger formed of aluminum alloy including forming the aluminum alloy brazing sheet according to the present invention into a fin shape to prepare fins, setting the fins inside a tube formed of aluminum alloy, and performing brazing, without applying flux, in an inert gas atmosphere with an oxygen concentration limited to 50 ppm or lower. The fins set inside a tube of the heat exchanger are prevented from directly contacting the brazing atmosphere. For this reason, influence of the oxygen concentration in the brazing atmosphere is slower than that in the case of setting the fins between tubes. However, because the brazing atmosphere enters the tube through an inlet/outlet provided in parts of the tube, it is required to set the oxygen concentration in the brazing atmosphere to 50 ppm or lower. The oxygen concentration in the brazing atmosphere exceeding 50 ppm causes difficulty in securing of sound brazability.

The inventors of the present invention have conducted a detailed investigation of defectiveness of buckling of distal end portions of the fins and unsound formation of a fillet, and found that it is not mainly caused by decrease in the melting point due to contained Mg or decrease in flowability due to a small thickness of the brazing material layer. The inventors have found that buckling of the distal end portions of the fins is not caused by increase in dissolution quantity of the core material into the molten brazing material, but by penetration of the molten brazing material into the grain boundary of the core material. The inventors have also found that defective formation of a fillet in the joined portion is caused by insufficiency of supply of brazing material to the joined portion, due to penetration of the molten brazing material into the grain boundary of the core material in the general portion of the fins. The inventors have found that each of the defectiveness is caused by miniaturization of the grain size of the core material.

For this reason, although the Mg content of the core material to secure joining property is regarded as at least 0.2 mass % in prior art, the inventors of the present invention have set the Mg content in the core material to 0.2 mass % or smaller, and set the thickness of the brazing material to 0.012 mm or smaller. In this way, the inventors have found that sufficient diffusion of Mg into the surface of the brazing material can be secured, even when the Mg content in the core material is set to 0.2 mass % or smaller. In addition, with respect to defective brazing caused by reduction in the absolute quantity of molten brazing material due to setting of the thickness of the brazing material to 0.012 mm or smaller, the inventors of the present invention have found that setting the Mg content in the core material to 0.2 mass % or smaller suppresses miniaturization of recrystallized grains in the core material in brazing heating, reduces grain boundary penetration of the molten brazing material into the core material, and consequently secures the absolute quantity of molten brazing material contributing to formation of a fillet necessary for sound brazing. The inventors have found that this structure enables formation of a sound fillet, and reduces grain boundary penetration of the brazing material into the core material in brazing heating, to prevent buckling of distal end portions of fins.

The following is an explanation of examples of the present invention, to prove the effect thereof. These examples indicate an embodiment of the present invention, and the present invention is not limited thereto.

### EXAMPLES

Table 1 (Examples) and Table 2 (Comparative Examples) list evaluated materials. Brazing sheets A1 to A32 (Examples) and B1 to B19 (Comparative Examples) having thicknesses of 0.05 mm, 0.07 mm, 0.074 mm, and 0.1 mm were prepared by a conventional method. Each of the brazing sheets has a structure in which a brazing material clads both side surfaces of a core material. The manufacturing process was performed in the order of casting, machining (the core material and the brazing material), hot rolling (brazing material), hot clad rolling, cold rolling, intermediate annealing, and cold rolling, and the material finished to be refined to H14 was subjected to fin processing with a fin forming machine. Some of the materials were immersed in an acid or alkaline solution at any of the stage after hot clad rolling, the stage after intermediate annealing, and the stage before fin forming, to perform etching. The etching depth was determined from GD-OES analysis results before and after etching.

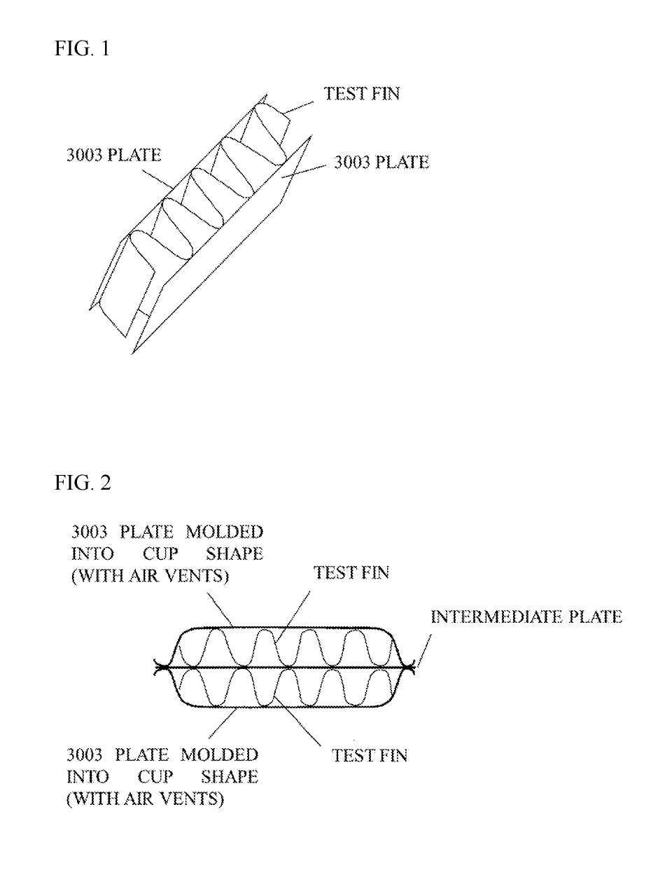

FIG. 1 illustrates a test piece for outer fins set between tubes in a parallel-flow-type heat exchanger or a stacked type heat exchanger. Joined portions with the 3003 members existed in the left and the right, and both the joined portions were evaluated. FIG. 2 illustrates a test piece for inner fins set inside a tube. In the sectional view of FIG. 2, joined portions with the 3003 members (with air vents to regulate the atmosphere) molded into a cup shape are positioned in upper and lower portions, and both the joined portions were evaluated. A joined portion with an intermediate plate including both side surfaces formed of brazing sheets was excluded from targets of evaluation.

Braze joining was performed as follows. A nitrogen gas furnace formed of two-chambered furnace having an internal capacity of 0.4 m³ and including a preheat chamber and a brazing chamber, and each of test pieces with a temperature increased to 450° C. in the preheat chamber was inserted into the brazing chamber. Each of the test pieces was increased from 450° C. to 577° C. in the brazing chamber for 320 seconds or 160 seconds, and brazed at a temperature of 595° C. that the test piece reached. Thereafter, each of the test pieces was cooled to 570° C. in the preheat chamber, and taken out of the furnace. The oxygen concentration in brazing was regulated by changing the flow rate of the nitrogen gas.

The brazability of each of the test pieces was evaluated as follows. Brazing was performed on each of test pieces obtained by combining fins obtained by forming the brazing sheet, plates of the 3003 members or press molded members, and a brazing sheet of 4045/3003/4045, and the fins were separated from the joined portions with the 3003 members. Because a track of a brazed fillet was left in the joined portions when any fillet was formed, the ratio of the sum total of the lengths of the tracks of a fillet to the sum total of the lengths of the joined portions was regarded as fin joining ratio (%). Evaluation was made as follows in accordance with the magnitude of the joining ratio. The first decimal place was rounded off, and the test pieces with the joining rate of 80% or higher were determined as practicable ones that passed the test.

⊙⊙⊙: joining ratio of 100%

⊙⊙: joining ratio of 95% to 99%

⊙: joining ratio of 90% to 94%

∘: joining ratio of 80% to 89%

▴: joining ratio of 50% to 79%

x: joining ratio <50%

No test evaluation was performed on the materials in which defectiveness occurred in the middle of manufacturing.

In addition, the average grain size of the core material after heating test at 595° C. was measured by the following method.

The brazing sheet was heated for three minutes at 595° C. in an inert gas atmosphere, without being molded into a fin shape, and thereafter cooled. Thereafter, the surface of the brazing sheet was polished, to expose the core material. Thereafter, a surface polarization microphotograph was taken, and the number of grains was counted, to use the value converted into a diameter corresponding to a circle.

Evaluation Results of Examples

Table 3 lists evaluation results of examples. It was verified that each of the examples listed in Table 3 showed the joining ratio of 80% or higher, and practicability of the present invention was proved. Improvement in joining property was verified in each of No. C14 to C19 and C24 to C26 subjected to etching by 5 nm or more by acid at the stage after hot clad rolling or later.

Research after brazing verified that the average grain size of the core material of each of the materials according to the present invention with the Mg content of the core material set to 0.1 mass % to 0.2 mass % was an average grain size exceeding 50 μm. For this reason, sound joining was performed without causing grain boundary penetration of the molten brazing material into the core material.

Evaluation Results of Comparative Examples for Outer Fins

Table 4 lists evaluation results of comparative examples. In the test piece of No. B2 with the Mg content of the core material set to 0.25 mass %, marked collapse occurred in the distal end portions of the fins due to grain boundary penetration of the molten brazing material into the core material. In research of the test piece after brazing, the average grain size was in a fine state smaller than 50 μm. In particular, in the fin distal end portions on which the molten brazing material concentrated, grain boundary penetration into the core material occurred intensely.

In the test piece of No. B5 with the Si content in the brazing material smaller than 6 mass %, the joining ratio was lower than 80% due to insufficiency of flowing brazing material. The test piece of No. B6 with the Si content exceeding 13 mass % was not subjected to experiment, because cracks occurred in rolling of the material.

In the test pieces of No. B7 with the Li content in the brazing material exceeding 0.05 mass %, No. B8 with the Bi content exceeding 0.1 mass %, and No. B9 with the Mg content exceeding 0.1 mass %, oxidation was progressed with Li, Bi, and Mg during heating, and the joining ratio was lower than 80%.

Evaluation Results of Comparative Examples for Inner Fins

Table 4 lists evaluation results of comparative examples. In the test piece (No. D9) using No. B3 including the core material having the Mg content smaller than 0.05 mass %, the fin joining ratio was lower than 80%. In the test piece of No. B4 with the Mg content in the core material exceeding 0.2 mass %, marked collapse occurred in the fin distal end portions due to grain boundary penetration of the molten brazing material into the core material. The average grain size after brazing was in a fine state smaller than 50 μm, but the degree of collapse of the distal end portions of the fins was slight, because the core material had a large thickness. However, because collapse of the distal end portions of the fins is accompanied by a reduction in height, the collapse is not preferable because it increases clearance of other joined portions, in particular, in heat exchangers with a large number of stacked layers, and causes defective joining.

TABLE 1

| | | Thickness (mm) | | | | | | | | | | | | | |
|---|---|---|---|---|---|---|---|---|---|---|---|---|---|---|---|
| | | Respective | Sheet | Chemical Components (mass %) | | | | | | | | | | Mg/ | Applied |
| No. | Structure | Regions | Thickness | Si | Fe | Cu | Mn | Mg | Zn | Ti | Zr | Li | Bi | Mn | Region |
| A1 | Brazing | 0.005 | 0.05 | 10 | — | — | — | — | — | — | — | — | — | 0.083 | Outer |
| | Material | | | | | | | | | | | | | | Fin |
| | Core | 0.04 | | — | 0.2 | — | 1.2 | 0.1 | 1.2 | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| A2 | Brazing | 0.005 | 0.05 | 10 | — | — | — | — | — | — | — | — | — | 0.167 | Outer |
| | Material | | | | | | | | | | | | | | Fin |
| | Core | 0.04 | | — | 0.2 | — | 1.2 | 0.2 | 1.2 | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| A3 | Brazing | 0.01 | 0.1 | 10 | — | — | — | — | — | — | — | — | — | 0.083 | Inner |
| | Material | | | | | | | | | | | | | | Fin |
| | Core | 0.08 | | — | 0.2 | — | 1.2 | 0.1 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| A4 | Brazing | 0.01 | 0.1 | 10 | — | — | — | — | — | — | — | — | — | 0.167 | Inner |
| | Material | | | | | | | | | | | | | | Fin |
| | Core | 0.08 | | — | 0.2 | — | 1.2 | 0.2 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| A5 | Brazing | 0.007 | 0.07 | 6 | — | — | — | — | — | — | — | — | — | 0.125 | Outer |
| | Material | | | | | | | | | | | | | | Fin |
| | Core | 0.056 | | — | 0.2 | — | 1.2 | 0.15 | 2.9 | — | — | — | — | | |
| | Material | | | | | | | | | | | | | | |
| | Brazing | 0.007 | | 6 | — | — | — | — | — | — | — | — | — | | |
| | Material | | | | | | | | | | | | | | |
| A6 | Brazing | 0.007 | 0.07 | 10 | — | — | — | — | — | — | — | — | — | 0.125 | Outer |
| | Material | | | | | | | | | | | | | | Fin |
| | Core | 0.056 | | — | 0.2 | — | 1.2 | 0.15 | 1.2 | — | — | — | — | | |
| | Material | | | | | | | | | | | | | | |
| | Brazing | 0.007 | | 10 | — | — | — | — | — | — | — | — | — | | |
| | Material | | | | | | | | | | | | | | |
| A7 | Brazing | 0.007 | 0.07 | 13 | — | — | — | — | — | — | — | — | — | 0.125 | Outer |
| | Material | | | | | | | | | | | | | | Fin |
| | Core | 0.056 | | — | 0.2 | — | 1.2 | 0.15 | 1.2 | — | — | — | — | | |
| | Material | | | | | | | | | | | | | | |
| | Brazing | 0.007 | | 13 | — | — | — | — | — | — | — | — | — | | |
| | Material | | | | | | | | | | | | | | |
| A8 | Brazing | 0.007 | 0.07 | 10 | — | — | — | — | — | — | — | 0.004 | — | 0.083 | Outer |
| | Material | | | | | | | | | | | | | | Fin |
| | Core | 0.056 | | — | 0.2 | — | 1.2 | 0.1 | 1.2 | — | — | — | — | | |
| | Material | | | | | | | | | | | | | | |
| | Brazing | 0.007 | | 10 | — | — | — | — | — | — | — | 0.004 | — | | |
| | Material | | | | | | | | | | | | | | |
| A9 | Brazing | 0.007 | 0.07 | 10 | — | — | — | — | — | — | — | 0.05 | — | 0.083 | Outer |
| | Material | | | | | | | | | | | | | | Fin |
| | Core | 0.056 | | — | 0.2 | — | 1.2 | 0.1 | 1.2 | — | — | — | — | | |
| | Material | | | | | | | | | | | | | | |
| | Brazing | 0.007 | | 10 | — | — | — | — | — | — | — | 0.05 | — | | |
| | Material | | | | | | | | | | | | | | |
| A10 | Brazing | 0.007 | 0.07 | 10 | — | — | — | — | — | — | — | — | 0.004 | 0.083 | Outer |
| | Material | | | | | | | | | | | | | | Fin |
| | Core | 0.056 | | — | 0.2 | — | 1.2 | 0.1 | 1.2 | — | — | — | — | | |
| | Material | | | | | | | | | | | | | | |
| | Brazing | 0.007 | | 10 | — | — | — | — | — | — | — | — | 0.004 | | |
| | Material | | | | | | | | | | | | | | |
| A11 | Brazing | 0.007 | 0.07 | 10 | — | — | — | — | — | — | — | — | 0.1 | 0.083 | Outer |
| | Material | | | | | | | | | | | | | | Fin |
| | Core | 0.056 | | — | 0.2 | — | 1.2 | 0.1 | 1.2 | — | — | — | — | | |
| | Material | | | | | | | | | | | | | | |
| | Brazing | 0.007 | | 10 | — | — | — | — | — | — | — | — | 0.1 | | |
| | Material | | | | | | | | | | | | | | |
| A12 | Brazing | 0.007 | 0.07 | 10 | — | — | — | 0.02 | — | — | — | — | — | 0.125 | Outer |
| | Material | | | | | | | | | | | | | | Fin |
| | Core | 0.056 | | — | 0.2 | — | 1.2 | 0.15 | 1.2 | — | — | — | — | | |
| | Material | | | | | | | | | | | | | | |
| | Brazing | 0.007 | | 10 | — | — | — | 0.02 | — | — | — | — | — | | |
| | Material | | | | | | | | | | | | | | |
| A13 | Brazing | 0.007 | 0.07 | 10 | — | — | — | 0.1 | — | — | — | — | — | 0.125 | Outer |
| | Material | | | | | | | | | | | | | | Fin |
| | Core | 0.056 | | — | 0.2 | — | 1.2 | 0.15 | 1.2 | — | — | — | — | | |
| | Material | | | | | | | | | | | | | | |
| | Brazing | 0.007 | | 10 | — | — | — | 0.1 | — | — | — | — | — | | |
| | Material | | | | | | | | | | | | | | |
| A14 | Brazing | 0.007 | 0.07 | 10 | — | — | — | — | — | — | — | 0.02 | 0.02 | 0.083 | Outer |
| | Material | | | | | | | | | | | | | | Fin |
| | Core | 0.056 | | — | 0.2 | — | 1.2 | 0.1 | 1.2 | — | — | — | — | | |
| | Material | | | | | | | | | | | | | | |
| | Brazing | 0.007 | | 10 | — | — | — | — | — | — | — | 0.02 | 0.02 | | |
| | Material | | | | | | | | | | | | | | |
| A15 | Brazing | 0.01 | 0.1 | 10 | — | — | — | — | — | — | — | 0.02 | 0.02 | 0.083 | Inner |
| | Material | | | | | | | | | | | | | | Fin |
| | Core | 0.08 | | — | 0.2 | — | 1.2 | 0.1 | — | — | — | — | — | | |
| | Material | | | | | | | | | | | | | | |
| | Brazing | 0.01 | | 10 | — | — | — | — | — | — | — | 0.02 | 0.02 | | |
| | Material | | | | | | | | | | | | | | |
| A16 | Brazing | 0.01 | 0.1 | 10 | — | — | — | — | — | — | — | 0.02 | 0.02 | 0.125 | Inner |
| | Material | | | | | | | | | | | | | | Fin |
| | Core | 0.08 | | — | 0.2 | — | 1.2 | 0.15 | — | — | — | — | — | | |
| | Material | | | | | | | | | | | | | | |
| | Brazing | 0.01 | | 10 | — | — | — | — | — | — | — | 0.02 | 0.02 | | |
| | Material | | | | | | | | | | | | | | |
| A17 | Brazing | 0.005 | 0.05 | 10 | — | — | — | — | — | — | — | — | — | 0.125 | Outer |
| | Material | | | | | | | | | | | | | | Fin |
| | Core | 0.04 | | — | — | — | 0.8 | 0.1 | — | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| A18 | Brazing | 0.005 | 0.05 | 10 | — | — | — | — | — | — | — | — | — | 0.083 | Outer |
| | Material | | | | | | | | | | | | | | Fin |
| | Core | 0.04 | | — | — | — | 1.2 | 0.1 | — | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| A19 | Brazing | 0.005 | 0.05 | 10 | — | — | — | — | — | — | — | — | — | 0.056 | Outer |
| | Material | | | | | | | | | | | | | | Fin |
| | Core | 0.04 | | — | — | — | 1.8 | 0.1 | — | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| A20 | Brazing | 0.01 | 0.1 | 10 | — | — | — | — | — | — | — | — | — | 0.125 | Inner |
| | Material | | | | | | | | | | | | | | Fin |
| | Core | 0.08 | | — | — | — | 0.8 | 0.1 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| A21 | Brazing | 0.01 | 0.1 | 10 | — | — | — | — | — | — | — | — | — | 0.083 | Inner |
| | Material | | | | | | | | | | | | | | Fin |
| | Core | 0.08 | | — | — | — | 1.2 | 0.1 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| A22 | Brazing | 0.01 | 0.1 | 10 | — | — | — | — | — | — | — | — | — | 0.056 | Inner |
| | Material | | | | | | | | | | | | | | Fin |
| | Core | 0.08 | | — | — | — | 1.8 | 0.1 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| A23 | Brazing | 0.005 | 0.05 | 10 | — | — | — | — | — | — | — | — | — | 0.042 | Outer |
| | Material | | | | | | | | | | | | | | Fin |
| | Core | 0.04 | | — | — | — | 1.2 | 0.05 | — | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| A24 | Brazing | 0.005 | 0.05 | 10 | — | — | — | — | — | — | — | — | — | 0.167 | Outer |
| | Material | | | | | | | | | | | | | | Fin |
| | Core | 0.04 | | — | — | — | 1.2 | 0.2 | — | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| A25 | Brazing | 0.01 | 0.1 | 10 | — | — | — | — | — | — | — | — | — | 0.167 | Inner |
| | Material | | | | | | | | | | | | | | Fin |
| | Core | 0.08 | | — | — | — | 1.2 | 0.2 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| A26 | Brazing | 0.005 | 0.05 | 10 | — | — | — | — | — | — | — | — | — | 0.125 | Outer |
| | Material | | | | | | | | | | | | | | Fin |
| | Core | 0.04 | | — | 0.2 | — | 0.8 | 0.1 | 1.2 | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| A27 | Brazing | 0.005 | 0.05 | 10 | — | — | — | — | — | — | — | — | — | 0.111 | Outer |
| | Material | | | | | | | | | | | | | | Fin |
| | Core | 0.04 | | — | 0.2 | — | 1.8 | 0.2 | 1.2 | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| A28 | Brazing | 0.01 | 0.1 | 10 | — | — | — | — | — | — | — | — | — | 0.125 | Inner |
| | Material | | | | | | | | | | | | | | Fin |
| | Core | 0.08 | | — | 0.2 | — | 0.8 | 0.1 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| A29 | Brazing | 0.01 | 0.1 | 10 | — | — | — | — | — | — | — | — | — | 0.111 | Inner |
| | Material | | | | | | | | | | | | | | Fin |
| | Core | 0.08 | | — | 0.2 | — | 1.8 | 0.2 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| A30 | Brazing | 0.012 | 0.074 | 10 | — | — | — | — | — | — | — | — | — | 0.083 | Outer |
| | Material | | | | | | | | | | | | | | Fin |
| | Core | 0.05 | | — | — | — | 1.2 | 0.1 | — | — | — | — | — | | |
| | Material | | | | | | | | | | | | | | |
| | Brazing | 0.012 | | 10 | — | — | — | — | — | — | — | — | — | | |
| | Material | | | | | | | | | | | | | | |
| A31 | Brazing | 0.012 | 0.074 | 10 | — | — | — | — | — | — | — | — | — | 0.042 | Outer |
| | Material | | | | | | | | | | | | | | Fin |
| | Core | 0.05 | | — | — | — | 1.2 | 0.05 | — | — | — | — | — | | |
| | Material | | | | | | | | | | | | | | |
| | Brazing | 0.012 | | 10 | — | — | — | — | — | — | — | — | — | | |
| | Material | | | | | | | | | | | | | | |
| A32 | Brazing | 0.005 | 0.05 | 10 | — | — | — | — | — | — | — | — | — | 0.058 | Outer |
| | Material | | | | | | | | | | | | | | Fin |
| | Core | 0.04 | | — | 0.2 | — | 1.2 | 0.07 | 1.2 | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |

TABLE 2

| | | Thickness (mm) | | | | | | | | | | | | | |
|---|---|---|---|---|---|---|---|---|---|---|---|---|---|---|---|
| | | Respective | Sheet | Chemical Components (mass %) | | | | | | | | | | Mg/ | Applied |
| No. | Structure | Regions | Thickness | Si | Fe | Cu | Mn | Mg | Zn | Ti | Zr | Li | Bi | Mn | Region |
| B2 | Brazing | 0.005 | 0.05 | 10 | — | — | — | — | — | — | — | — | — | 0.208 | Outer |
| | Material | | | | | | | | | | | | | | Fin |
| | Core | 0.04 | | — | 0.2 | — | 1.2 | 0.25 | 1.2 | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| B3 | Brazing | 0.01 | 0.1 | 10 | — | — | — | — | — | — | — | — | — | 0.025 | Inner |
| | Material | | | | | | | | | | | | | | Fin |
| | Core | 0.08 | | — | 0.2 | — | 1.2 | 0.03 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| B4 | Brazing | 0.01 | 0.1 | 10 | — | — | — | — | — | — | — | — | — | 0.250 | Inner |
| | Material | | | | | | | | | | | | | | Fin |
| | Core | 0.08 | | — | 0.2 | — | 1.2 | 0.3 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| B5 | Brazing | 0.007 | 0.07 | 4 | — | — | — | — | — | — | — | — | — | 0.125 | Outer |
| | Material | | | | | | | | | | | | | | Fin |
| | Core | 0.056 | | — | 0.2 | — | 1.2 | 0.15 | 2.9 | — | — | — | — | | |
| | Material | | | | | | | | | | | | | | |
| | Brazing | 0.007 | | 4 | — | — | — | — | — | — | — | — | — | | |
| | Material | | | | | | | | | | | | | | |
| B6 | Brazing | 0.007 | 0.07 | 16 | — | — | — | — | — | — | — | — | — | 0.125 | Cuter |
| | Material | | | | | | | | | | | | | | Fin |
| | Core | 0.056 | | — | 0.2 | — | 1.2 | 0.15 | 1.2 | — | — | — | — | | |
| | Material | | | | | | | | | | | | | | |
| | Brazing | 0.007 | | 16 | — | — | — | — | — | — | — | — | — | | |
| | Material | | | | | | | | | | | | | | |
| B7 | Brazing | 0.007 | 0.07 | 10 | — | — | — | — | — | — | — | 0.08 | — | 0.083 | Outer |
| | Material | | | | | | | | | | | | | | Fin |
| | Core | 0.056 | | — | 0.2 | — | 1.2 | 0.1 | 1.2 | — | — | — | — | | |
| | Material | | | | | | | | | | | | | | |
| | Brazing | 0.007 | | 10 | — | — | — | — | — | — | — | 0.08 | — | | |
| | Material | | | | | | | | | | | | | | |
| B8 | Brazing | 0.007 | 0.07 | 10 | — | — | — | — | — | — | — | — | 0.15 | 0.083 | Outer |
| | Material | | | | | | | | | | | | | | Fin |
| | Core | 0.056 | | — | 0.2 | — | 1.2 | 0.1 | 1.2 | — | — | — | — | | |
| | Material | | | | | | | | | | | | | | |
| | Brazing | 0.007 | | 10 | — | — | — | — | — | — | — | — | 0.15 | | |
| | Material | | | | | | | | | | | | | | |
| B9 | Brazing | 0.007 | 0.07 | 10 | — | — | — | 0.15 | — | — | — | — | — | 0.125 | Outer |
| | Material | | | | | | | | | | | | | | Fin |
| | Core | 0.056 | | — | 0.2 | — | 1.2 | 0.15 | 1.2 | — | — | — | — | | |
| | Material | | | | | | | | | | | | | | |
| | Brazing | 0.007 | | 10 | — | — | — | 0.15 | — | — | — | — | — | | |
| | Material | | | | | | | | | | | | | | |
| B10 | Brazing | 0.005 | 0.05 | 10 | — | — | — | — | — | — | — | — | — | 0.167 | Outer |
| | Material | | | | | | | | | | | | | | Fin |
| | Core | 0.04 | | — | — | — | 0.6 | 0.1 | — | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| B11 | Brazing | 0.005 | 0.05 | 10 | — | — | — | — | — | — | — | — | — | 0.050 | Outer |
| | Material | | | | | | | | | | | | | | Fin |
| | Core | 0.04 | | — | — | — | 2.0 | 0.1 | — | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| B12 | Brazing | 0.01 | 0.1 | 10 | — | — | — | — | — | — | — | — | — | 0.167 | Inner |
| | Material | | | | | | | | | | | | | | Fin |
| | Core | 0.08 | | — | — | — | 0.6 | 0.1 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| B13 | Brazing | 0.01 | 0.1 | 10 | — | — | — | — | — | — | — | — | — | 0.050 | Inner |
| | Material | | | | | | | | | | | | | | Fin |
| | Core | 0.08 | | — | — | — | 2.0 | 0.1 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| B14 | Brazing | 0.005 | 0.05 | 10 | — | — | — | — | — | — | — | — | — | 0.025 | Outer |
| | Material | | | | | | | | | | | | | | Fin |
| | Core | 0.04 | | — | — | — | 1.2 | 0.03 | — | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| B15 | Brazing | 0.005 | 0.05 | 10 | — | — | — | — | — | — | — | — | — | 0.208 | Outer |
| | Material | | | | | | | | | | | | | | Fin |
| | Core | 0.04 | | — | — | — | 1.2 | 0.25 | — | — | — | — | — | | |
| | Material | | | | | | | | | | | | | | |
| | Brazing | 0.005 | | 10 | — | — | — | — | — | — | — | — | — | | |
| | Material | | | | | | | | | | | | | | |
| B16 | Brazing | 0.01 | 0.1 | 10 | — | — | — | — | — | — | — | — | — | 0.025 | Inner |
| | Material | | | | | | | | | | | | | | Fin |
| | Core | 0.08 | | — | — | — | 1.2 | 0.03 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| B17 | Brazing | 0.01 | 0.1 | 10 | — | — | — | — | — | — | — | — | — | 0.208 | Inner |
| | Material | | | | | | | | | | | | | | Fin |
| | Core | 0.08 | | — | — | — | 1.2 | 0.25 | — | — | — | — | — | | |
| | Material | | | | | | | | | | | | | | |
| | Brazing | 0.01 | | 10 | — | — | — | — | — | — | — | — | — | | |
| | Material | | | | | | | | | | | | | | |
| B18 | Brazing | 0.018 | 0.07 | 10 | — | — | — | — | — | — | — | — | — | 0.042 | Outer |
| | Material | | | | | | | | | | | | | | Fin |
| | Core | 0.034 | | — | — | — | 1.2 | 0.05 | — | — | — | — | — | | |
| | Material | | | | | | | | | | | | | | |
| | Brazing | 0.018 | | 10 | — | — | — | — | — | — | — | — | — | | |
| | Material | | | | | | | | | | | | | | |
| B19 | Brazing | 0.018 | 0.07 | 10 | — | — | — | — | — | — | — | — | — | 0.167 | Outer |
| | Material | | | | | | | | | | | | | | Fin |
| | Core | 0.034 | | — | — | — | 1.2 | 0.2 | — | — | — | — | — | | |
| | Material | | | | | | | | | | | | | | |
| | Brazing | 0.018 | | 10 | — | — | — | — | — | — | — | — | — | | |
| | Material | | | | | | | | | | | | | | |

TABLE 3

| | | | | | | | | Average | | Collapse And | |
|---|---|---|---|---|---|---|---|---|---|---|---|
| | | | | | | | Oxygen | Grain Size | | Deformation | |
| | | | Etching | | | Heating | Concen- | Of Core | Fin | Of Distal | |
| | | Fin | Treatment | Treatment | Execution | Time | tration | Material | Joining | End Portion | |
| No. | Region | Material | Solution | Depth | Period | (450° C.→577° C.) | (ppm) | (μm) | Ratio | Of Fin | Evaluation |
| C1 | Outer | A1 | — | — | — | 320 | 28 | 110 | 82% | Not Exist | ◯ |
| | Fin | | | | | Seconds | | | | | |
| C2 | ↑ | A2 | — | — | — | ↑ | 30 | 60 | 81% | Not Exist | ◯ |
| C3 | ↑ | A2 | — | — | — | 160 | 30 | 65 | 83% | Not Exist | ◯ |
| | | | | | | Seconds | | | | | |
| C4 | ↑ | A5 | — | — | — | 320 | 28 | 80 | 84% | Not Exist | ◯ |
| | | | | | | Seconds | | | | | |
| C5 | ↑ | A6 | — | — | — | ↑ | 18 | 90 | 90% | Not Exist | ⊙ |
| C6 | ↑ | A7 | — | — | — | ↑ | 18 | 85 | 93% | Not Exist | ⊙ |
| C7 | ↑ | A8 | — | — | — | ↑ | 16 | 120 | 96% | Not Exist | ⊙⊙ |
| C8 | ↑ | A9 | — | — | — | ↑ | 16 | 120 | 93% | Not Exist | ⊙ |
| C9 | ↑ | A10 | — | — | — | ↑ | 17 | 105 | 93% | Not Exist | ⊙ |
| C10 | ↑ | A11 | — | — | — | ↑ | 17 | 110 | 92% | Not Exist | ⊙ |
| C11 | ↑ | A12 | — | — | — | ↑ | 16 | 70 | 92% | Not Exist | ⊙ |
| C12 | ↑ | A13 | — | — | — | ↑ | 16 | 75 | 94% | Not Exist | ⊙ |
| C13 | ↑ | A14 | — | — | — | ↑ | 17 | 115 | 96% | Not Exist | ⊙⊙ |
| C14 | ↑ | A2 | 1% | 5 nm | Before | 160 | 18 | 65 | 92% | Not Exist | ⊙ |
| | | | Hydrofluoric | | Fin | Seconds | | | | | |
| | | | Acid | | Forming | | | | | | |
| C15 | ↑ | ↑ | ↑ | 100 nm | ↑ | ↑ | 18 | 55 | 96% | Not Exist | ⊙⊙ |
| C16 | ↑ | ↑ | ↑ | 130 nm | After | ↑ | 18 | 60 | 93% | Not Exist | ⊙ |
| | | | | | Hot | | | | | | |
| | | | | | Rolling | | | | | | |
| C17 | ↑ | ↑ | ↑ | 110 nm | After | ↑ | 18 | 60 | 95% | Not Exist | ⊙⊙ |
| | | | | | Intermediate | | | | | | |
| | | | | | Annealing | | | | | | |
| C18 | ↑ | A8 | ↑ | 90 nm | Before | 320 | 18 | 125 | 100% | Not Exist | ⊙⊙⊙ |
| | | | | | Fin | Seconds | | | | | |
| | | | | | Forming | | | | | | |
| C19 | ↑ | A14 | ↑ | 80 nm | ↑ | ↑ | 18 | 110 | 100% | Not Exist | ⊙⊙⊙ |
| C20 | Inner | A3 | — | — | — | 320 | 42 | 60 | 82% | Not Exist | ◯ |
| | Fin | | | | | Seconds | | | | | |
| C21 | ↑ | A4 | — | — | — | ↑ | 42 | 50 | 86% | Not Exist | ◯ |
| C22 | ↑ | A15 | — | — | — | ↑ | 42 | 120 | 91% | Not Exist | ⊙ |
| C23 | ↑ | A16 | — | — | — | ↑ | 42 | 80 | 95% | Not Exist | ⊙⊙ |
| C24 | ↑ | A3 | 3% | 150 nm | Before | ↑ | 46 | 115 | 96% | Not Exist | ⊙⊙ |
| | | | Phosphoric | | Fin | | | | | | |
| | | | Acid | | Forming | | | | | | |
| | | | 5% | | | | | | | | |
| | | | Sulfuric | | | | | | | | |
| | | | Acid | | | | | | | | |
| C25 | ↑ | A15 | 1% | 160 nm | ↑ | ↑ | 46 | 110 | 100% | Not Exist | ⊙⊙⊙ |
| | | | Hydrofluoric | | | | | | | | |
| | | | Acid | | | | | | | | |
| C26 | ↑ | A16 | ↑ | 180 nm | ↑ | ↑ | 46 | 85 | 100% | Not Exist | ⊙⊙⊙ |
| C27 | Outer | A17 | 3% | 160 nm | After | 160 | 18 | 60 | 92% | Not Exist | ⊙ |
| | Fin | | Phosphoric | | Fin | Seconds | | | | | |
| | | | Acid | | Forming | | | | | | |
| | | | 5% | | | | | | | | |
| | | | Sulfuric | | | | | | | | |
| | | | Acid | | | | | | | | |
| C28 | ↑ | A18 | 1% | 170 nm | ↑ | ↑ | 24 | 115 | 93% | Not Exist | ⊙ |
| | | | Hydrofluoric | | | | | | | | |
| | | | Acid | | | | | | | | |
| C29 | ↑ | A19 | ↑ | 160 nm | ↑ | ↑ | 20 | 100 | 100% | Not Exist | ⊙⊙⊙ |
| C30 | Inner | A20 | — | — | — | 320 | 43 | 55 | 82% | Not Exist | ◯ |
| | Fin | | | | | Seconds | | | | | |
| C31 | ↑ | A21 | — | — | — | ↑ | 43 | 120 | 88% | Not Exist | ◯ |
| C32 | ↑ | A22 | — | — | — | ↑ | 43 | 105 | 83% | Not Exist | ◯ |
| C33 | Outer | A23 | — | — | — | 160 | 19 | 140 | 86% | Not Exist | ◯ |
| | Fin | | | | | Seconds | | | | | |
| C34 | ↑ | A24 | — | — | — | ↑ | 19 | 55 | 81% | Not Exist | ◯ |
| C35 | Inner | A25 | — | | — | 320 | 43 | 60 | 92% | Not Exist | ⊙ |
| | Fin | | | | | Seconds | | | | | |
| C36 | Outer | A26 | — | | — | 160 | 19 | 55 | 84% | Not Exist | ◯ |
| | Fin | | | | | Seconds | | | | | |
| C37 | ↑ | A27 | — | | — | ↑ | 19 | 65 | 86% | Not Exist | ◯ |
| C38 | Inner | A28 | — | | — | 320 | 36 | 65 | 84% | Not Exist | ◯ |
| | Fin | | | | | Seconds | | | | | |
| C39 | ↑ | A29 | — | | — | ↑ | 36 | 60 | 89% | Not Exist | ◯ |
| C40 | Outer | A30 | — | | — | 160 | 17 | 110 | 84% | Not Exist | ◯ |
| | Fin | | | | | Seconds | | | | | |
| C41 | ↑ | A31 | — | — | — | ↑ | 17 | 130 | 81% | Not Exist | ◯ |
| C42 | Outer | A32 | — | — | — | 160 | 18 | 70 | 82% | Not Exist | ◯ |
| | Fin | | | | | Seconds | | | | | |
| C43 | ↑ | A32 | 1% | 160 nm | After | ↑ | 18 | 70 | 84% | Not Exist | ◯ |
| | | | Hydrofluoric | | Fin | | | | | | |
| | | | Acid | | Forming | | | | | | |

TABLE 4

| | | | | | | | | Average | | Collapse And | |
|---|---|---|---|---|---|---|---|---|---|---|---|
| | | | | | | | Oxygen | Grain Size | | Deformation | |
| | | | Etching | | | Heating | Concen- | Of Core | Fin | Of Distal | |
| | | Fin | Treatment | Treatment | Execution | Time | tration | Material | Joining | End Portion | |
| No. | Region | Material | Solution | Depth | Period | (450° C.→577° C.) | (ppm) | (μm) | Ratio | Of Fin | Evaluation |
| D3 | Outer | B2 | — | — | — | 320 | 18 | 42 | 81% | Markedly | X |
| | Fin | | | | | Seconds | | | | Occurred | |
| D4 | ↑ | B5 | — | — | — | ↑ | 18 | 65 | 65% | Not Exist | ▴ |
| D5 | ↑ | B6 | — | — | — | — | — | — | — | — | Crack |
| | | | | | | | | | | | Occured In |
| | | | | | | | | | | | Rolling Of |
| | | | | | | | | | | | Material |
| D6 | ↑ | B7 | — | — | — | 320 | 18 | 115 | 68% | Not Exist | ▴ |
| | | | | | | Seconds | | | | | |
| D7 | ↑ | B8 | — | — | — | ↑ | 18 | 120 | 55% | Not Exist | ▴ |
| D8 | ↑ | B9 | — | — | — | ↑ | 18 | 75 | 78% | Not Exist | ▴ |
| D9 | Inner | B3 | — | — | — | ↑ | 42 | 140 | 0% | — | X |
| | Fin | | | | | | | | | | |
| D10 | ↑ | B4 | — | — | — | ↑ | 42 | 35 | 81% | Occurred | X |
| D11 | Outer | A14 | 5% NaOH | 80 nm | Before | ↑ | 16 | 115 | 78% | Not Exist | ▴ |
| | Fin | | | | Fin | | | | | | |
| | | | | | Forming | | | | | | |
| D12 | Inner | A16 | ↑ | 85 nm | ↑ | ↑ | 42 | 80 | 68% | Not Exist | ▴ |
| | Fin | | | | | | | | | | |
| D13 | Outer | B10 | — | — | — | 160 | 19 | 40 | 75% | Occurred | ▴ |
| | Fin | | | | | Seconds | | | | | |
| D14 | ↑ | B11 | — | — | — | — | — | — | — | — | Crack |
| | | | | | | | | | | | Occurred In |
| | | | | | | | | | | | Rolling Of |
| | | | | | | | | | | | Material |
| D15 | Inner | B12 | — | — | — | 320 | 42 | 38 | 77% | Occurred | ▴ |
| | Fin | | | | | Seconds | | | | | |
| D16 | ↑ | B13 | — | | — | — | — | — | — | — | Crack |
| | | | | | | | | | | | Occured In |
| | | | | | | | | | | | Rolling Of |
| | | | | | | | | | | | Material |
| D17 | Outer | B14 | — | — | — | 160 | 19 | 145 | 45% | — | X |
| | Fin | | | | | Seconds | | | | | |
| D18 | ↑ | B15 | — | — | — | ↑ | 19 | 42 | 70% | Occurred | ▴ |
| D19 | Inner | B16 | — | — | — | 320 | 42 | 140 | 52% | — | ▴ |
| | Fin | | | | | Seconds | | | | | |
| D20 | ↑ | B17 | — | — | — | ↑ | 42 | 38 | 76% | Occurred | ▴ |
| D21 | Outer | B18 | — | — | — | 160 | 19 | 130 | 79% | Occurred | ▴ |
| | Fin | | | | | Seconds | | | | | |
| D22 | ↑ | B19 | — | — | — | ↑ | 19 | 55 | 66% | Markedly | ▴ |
| | | | | | | | | | | Occurred | |

1. An aluminum alloy brazing sheet used for brazing in an inert gas atmosphere without using flux, the aluminum alloy brazing sheet comprising:
a brazing material formed of aluminum alloy including Si of 6 mass % to 13 mass % with the balance being Al and inevitable impurities cladding one side surface or both side surfaces of a core material formed of aluminum alloy including Mn of 0.8 mass % to 1.8 mass %, and Mg of 0.05 mass % to 0.20 mass % with the balance being Al and inevitable impurities, wherein
the brazing sheet has a thickness of 0.12 mm or smaller, and
the brazing material has a thickness of 0.012 mm or smaller.

2. The aluminum alloy brazing sheet according to claim 1, wherein the core material further includes one or two or more of Si of 1.0 mass % or smaller, Fe of 1.0 mass % or smaller, Cu of 0.5 mass % or smaller, Zn of 3.0 mass % or smaller, Ti of 0.2 mass % or smaller, and Zr of 0.5 mass % or smaller.

3. The aluminum alloy brazing sheet according to claim 1, wherein the brazing material further includes Li of 0.05 mass % or smaller.

4. The aluminum alloy brazing sheet according to claim 1, wherein the brazing material further includes one or two of Bi of 0.004 mass % to 0.1 mass % and Mg of 0.02 mass % to 0.1 mass %.

5. The aluminum alloy brazing sheet according to claim 1, wherein the core material is formed of aluminum alloy having an average grain size of 50 μm or larger after heating test at 595° C.

6. The aluminum alloy brazing sheet according to claim 1, wherein the core material is formed of aluminum alloy having an average grain size of 50 μm or larger after brazing heating test at 577° C. to 610° C.

7. The aluminum alloy brazing sheet according to claim 1, wherein a surface oxide film is subjected to separation removal treatment by acid cleaning, at a step after hot clad rolling in manufacturing of a material or after the material is finished.

8. The aluminum alloy brazing sheet according to claim 1, wherein a surface oxide film or a surface oxide film and the brazing material is etched to a thickness of 5 nm or larger by acid cleaning.

9. A method for manufacturing a heat exchanger formed of aluminum alloy, the method comprising:
forming the aluminum alloy brazing sheet according to claim 1 into a fin shape to prepare fins;
setting the fins between tubes formed of aluminum alloy; and
performing brazing, without applying flux, in an inert gas atmosphere with an oxygen concentration limited to 20 ppm or lower.

10. A method for manufacturing a heat exchanger formed of aluminum alloy, the method comprising:
forming the aluminum alloy brazing sheet according to claim 1 into a fin shape to prepare fins;
setting the fins inside a molded tube formed of aluminum alloy; and
performing brazing, without applying flux, in an inert gas atmosphere with an oxygen concentration limited to 50 ppm or lower.
